(19) United States
(12) Patent Application Publication
(10) Pub. No.: US 2024/0201691 A1
(43) Pub. Date: Jun. 20, 2024

(54) AUTO-ALIGNMENT LASER POINTING SYSTEM

(71) Applicant: AEGIVERSE Co., Ltd., Taoyuan (TW)

(72) Inventors: HUNG-PIN CHUNG, Kaohsiung (TW); SHIH-JU FAN, New Taipei City (TW)

(21) Appl. No.: 18/306,258

(22) Filed: Apr. 25, 2023

(30) Foreign Application Priority Data
Dec. 16, 2022 (TW) 111148377

(51) Int. Cl. G05D 1/02; G05D 1/08

(52) U.S. Cl. CPC G05D 1/0278; G05D 1/0816

(57) ABSTRACT

An auto-alignment laser pointing system is provided. The auto-alignment laser pointing system is used in an aircraft and includes a light source module, a beam control device, a tracking receiving module, and a gyroscope. The light source module is used for generating laser beam. The beam control device corresponds to the light source module, is disposed in a path of the laser beam, and controls the laser beam to form a projection beam based on a set attitude angle. The tracking receiving module is used for tracking the aircraft and receiving the projection beam, so as to know flight information of the aircraft. The gyroscope is electrically connected to the beam control device to detect an actual attitude angle of the beam control device. When a deviation angle is between the actual attitude angle and the set attitude angle, the beam control device is controlled by the gyroscope to rotate for eliminating the deviation angle, so the projection beam is ensured projecting to the tracking receiving module.

### CROSS-REFERENCE TO RELATED APPLICATIONS

This Application claims priority of Taiwan Patent Application No. 111148377, filed on Dec. 16, 2022, the entirety of which is incorporated by reference herein.

### BACKGROUND OF THE INVENTION

The present invention relates to a system, and, in particular, to an auto-alignment laser pointing system.

Free space optical communication (FSOC) is an optical communication technology that utilizes light to propagate in free space to transmit data wirelessly. After the miniaturization and practicalization of lasers and the increase in luminous intensity, their development will be accelerated.

Free space optical communication can theoretically transmit almost unlimited amount of data and at any location, such as at satellites, aircraft, ships, etc. Free space optical communication is often used in fields like spaceships, satellites, telecommunications, computer networks, disaster recovery, public transportation, security, military, etc.

In the field of satellites, satellites may be equipped with high-resolution cameras or other devices, so they will generate Terabyte (TB)-level data volumes. However, traditional microwave communications can only process limited amount of data, and it has become the limiting factor for satellite communications. On the other hand, due to the large divergence angle of the existing microwave communication technology, the range on the ground that can receive signal is quite wide, which increases the probability of being eavesdropped. Therefore, it is necessary to use a high-speed and high-directional communication scheme to transmit these data back to the earth. Free space optical communication is a very suitable technology at this moment. Because the satellite will orbit the earth, the satellite is usually equipped with a beam control device (such as a fast steering mirror (FSM)) to control the beam during the operation, so that the tracking receiving module on the ground (such as ground receiving station) can receive the beam to receive the data. However, existing free space optical communication technologies cannot meet all demands

### SUMMARY OF THE INVENTION

An auto-alignment laser pointing system is provided in some embodiments of the present disclosure. The auto-alignment laser pointing system is used in an aircraft and includes a light source module, a beam control device, a tracking receiving module, and a gyroscope. The light source module is used for generating a laser beam. The beam control device corresponds to the light source module, is disposed in a path of the laser beam, and controls the laser beam to form a projection beam based on a set attitude angle. The tracking receiving module is used for tracking the aircraft and receiving the projection beam, so as to know flight information of the aircraft. The gyroscope is electrically connected to the beam control device to detect an actual attitude angle of the beam control device. When a deviation angle is between the actual attitude angle and the set attitude angle, the beam control device is controlled by the gyroscope to rotate for eliminating the deviation angle, so the projection beam is ensured projecting to the tracking receiving module.

In some embodiments, the beam control device is a fast steering mirror (FSM).

In some embodiments, the beam control device includes a mirror used for reflecting the laser beam, a plurality of sensing modules placed corresponding to the mirror and used for generating at least one sensing information, and a control module electrically connected to the sensing modules, used for rotating the mirror based on the set attitude angle, and stopping rotating the mirror when the sensing information matches the set attitude angle, to control the laser beam for forming the projection beam.

In some embodiments, the gyroscope is a fiber optic gyroscope.

In some embodiments, the gyroscope includes a beam generation module used for generating a driving beam, and a fiber coil module connected to the beam generation module to receive the driving beam and be driven by the driving beam.

In some embodiments, the fiber coil module includes a coupler connected to the beam generation module and used to receive the driving beam and to split the driving beam, a modulation unit connected to the coupler, used for modulating the phase of the driving beam and splitting or combine the received driving beam, a fiber coil connected to the modulation unit and used to transmit the driving beam, a detector connected to the coupler to receive the driving beam and to transmit a detection signal accordingly, and a processing unit electrically connected to the modulation unit, the detector, and the control module, and used to process and analyze the driving beam and the detection signal.

In some embodiments, the processing unit is a field programmable gate array chip.

In some embodiments, the modulation unit is a multifunctional integrated optical chip.

In some embodiments, the gyroscope is one of a mechanical gyroscope, a micro-electro-mechanical system gyroscope, a laser gyroscope, a hemispherical resonator gyroscope, and an integrated optic gyroscope.

In some embodiments, the tracking receiving module is a ground receiving station.

### BRIEF DESCRIPTION OF DRAWINGS

Aspects of the present disclosure are best understood from the following detailed description when read with the accompanying figures. It should be noted that, in accordance with the standard practice in the industry, various features are not drawn to scale. In fact, the dimensions of the various features may be arbitrarily increased or reduced for clarity of discussion.

FIG. 1 to 3 illustrate the transmission of signals from satellite to a ground receiving station on earth using free space optical communication technology.

FIG. 4 is a schematic view of an auto-alignment laser pointing system.

FIG. 5 is a schematic view of some elements of an aircraft using the laser light pointing system.

FIG. 6 is a schematic view of some elements of the aircraft using the laser light pointing system.

FIGS. 7 and 8 are schematic views of the operation of the aircraft using this laser light pointing system.

### DETAILED DESCRIPTION OF THE INVENTION

Aspects of the present disclosure are best understood from the following detailed description when read with the accompanying Figs. The advantages and features of the present invention will be more clear from the following description and claims. It should be noted that all the drawings are in very simplified form and use imprecise scales, which are only used to facilitate and clearly assist the purpose of illustrating the embodiments of the present invention.

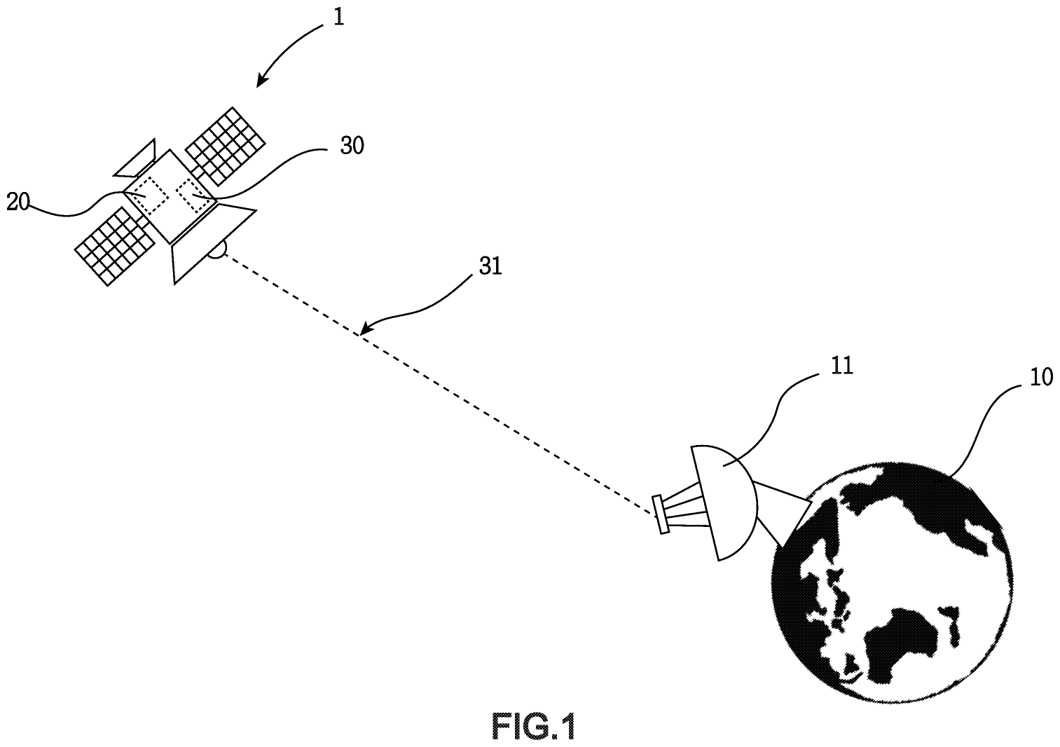

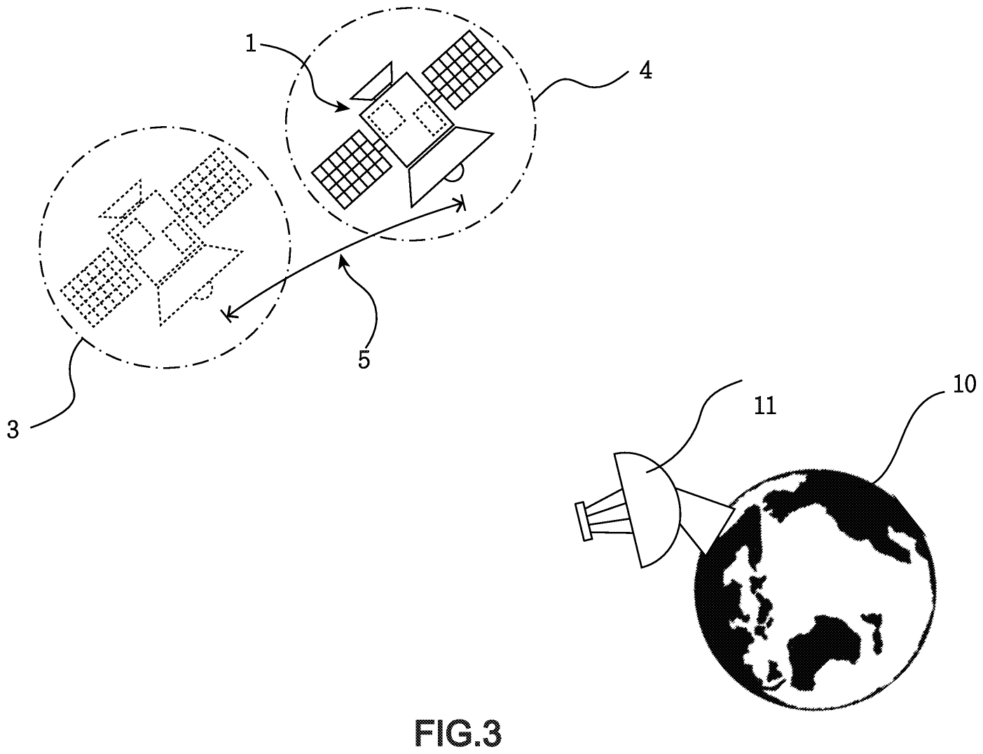

Please refer to FIG. 1 to FIG. 3, which illustrate the transmission of signals from satellite 1 to a ground receiving station 11 on earth 10 using free space optical communication technology. As shown in FIG. 1, the satellite 1 may include a beam control device 20 and a light source 30. The beam control device 20 may be used to control the direction of the beam 31 emitted by the light source 30 to reach the ground receiving station 11.

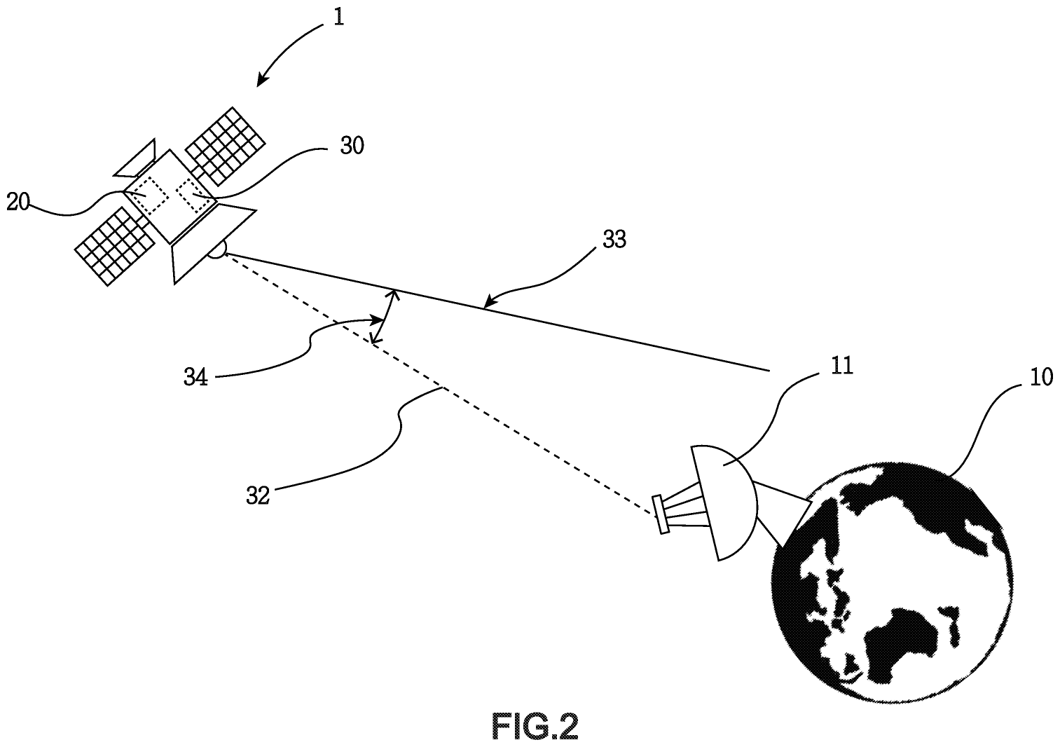

However, as shown in FIG. 2, during the operation of satellite 1 around the earth 10, since the satellite 1 is moving, the beam control device 20 will also move to control the beam 31, which may result in additional offset 34. For example, the beam 31 may deviate from the expected beam path 32 to the actual beam path 33, causing the ground receiving station 11 to fail to receive the beam 31. Additionally, the speed of a Low Earth Orbit (LEO) satellite moving around the earth 10 is about 24,700 km per hour, which means it only takes about 90 minutes to orbit around the earth 10 once. If the ground receiving station 11 does not receive the beam 31 and only provides feedback to the satellite 1 after confirming this, the satellite 1 may have already moved a long distance 5 from its original satellite position 3 to a new satellite position 4, or even out of the receiving range of the ground receiving station 11, thereby missing this receiving opportunity.

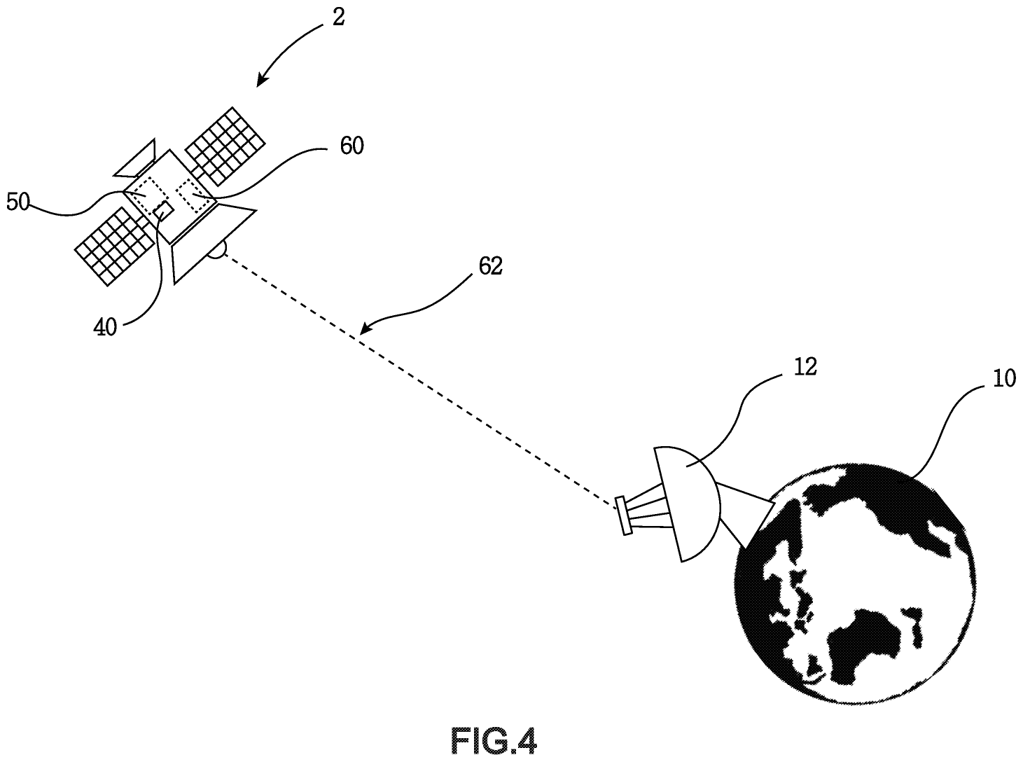

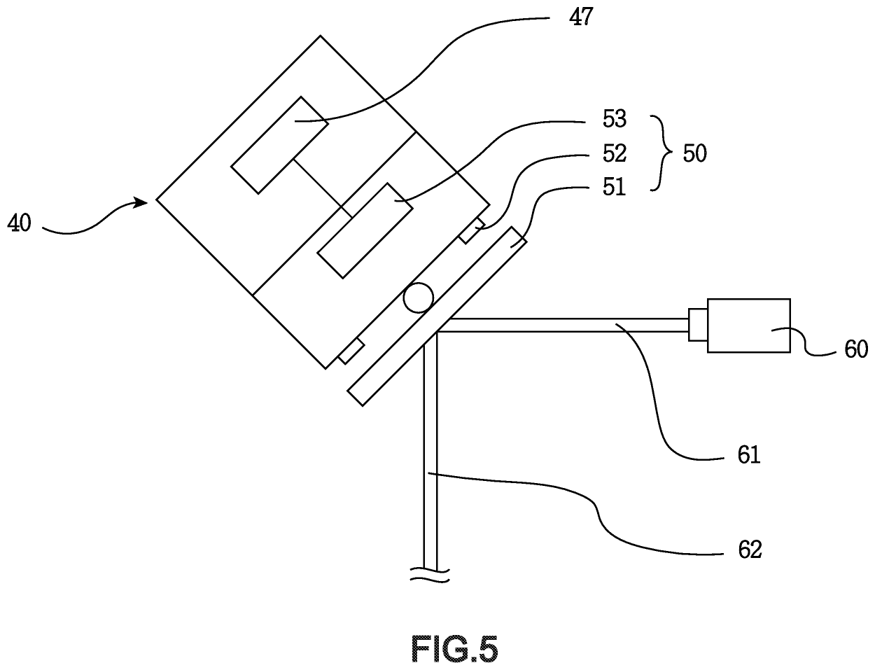

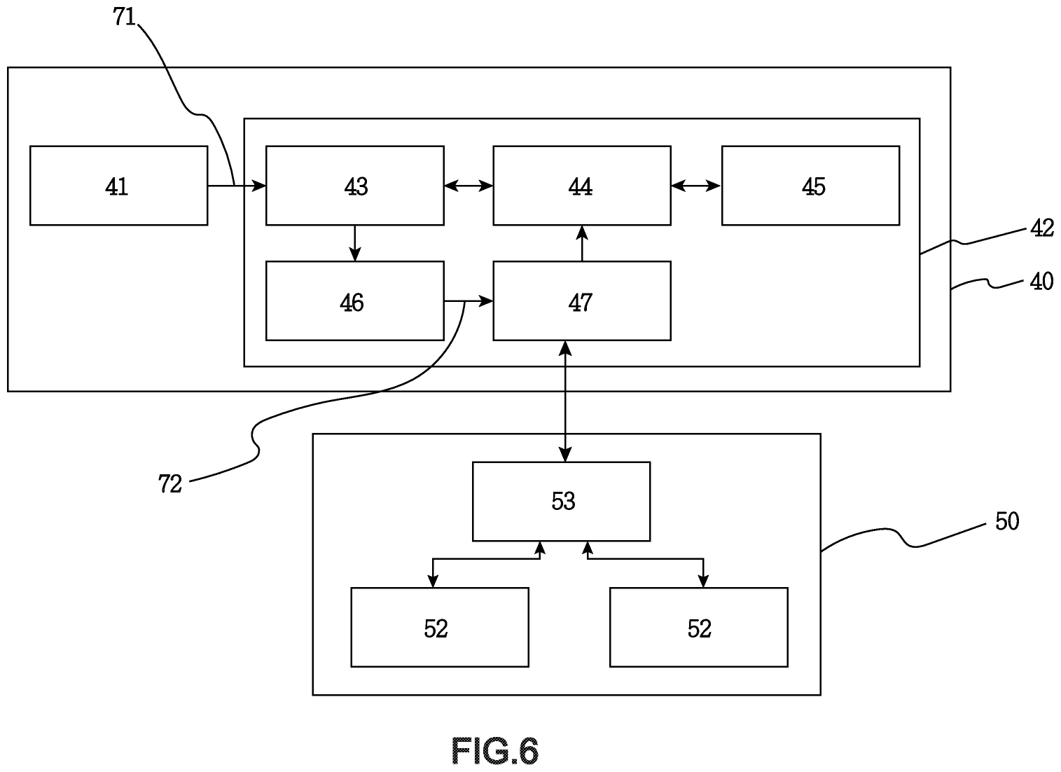

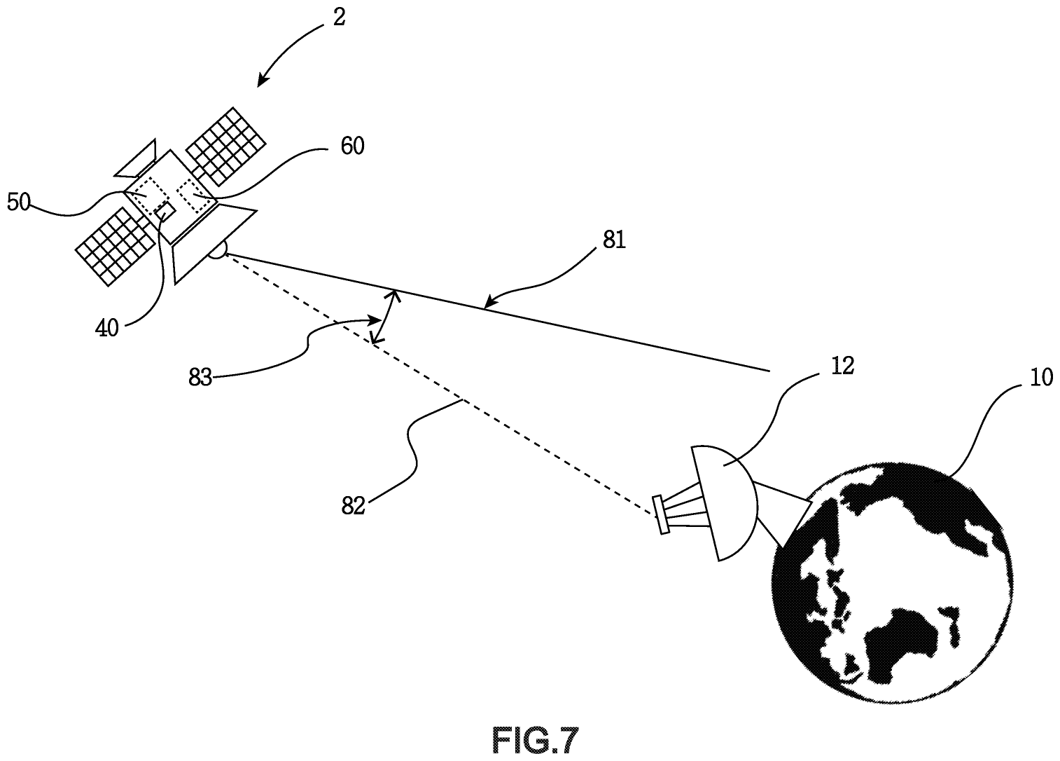

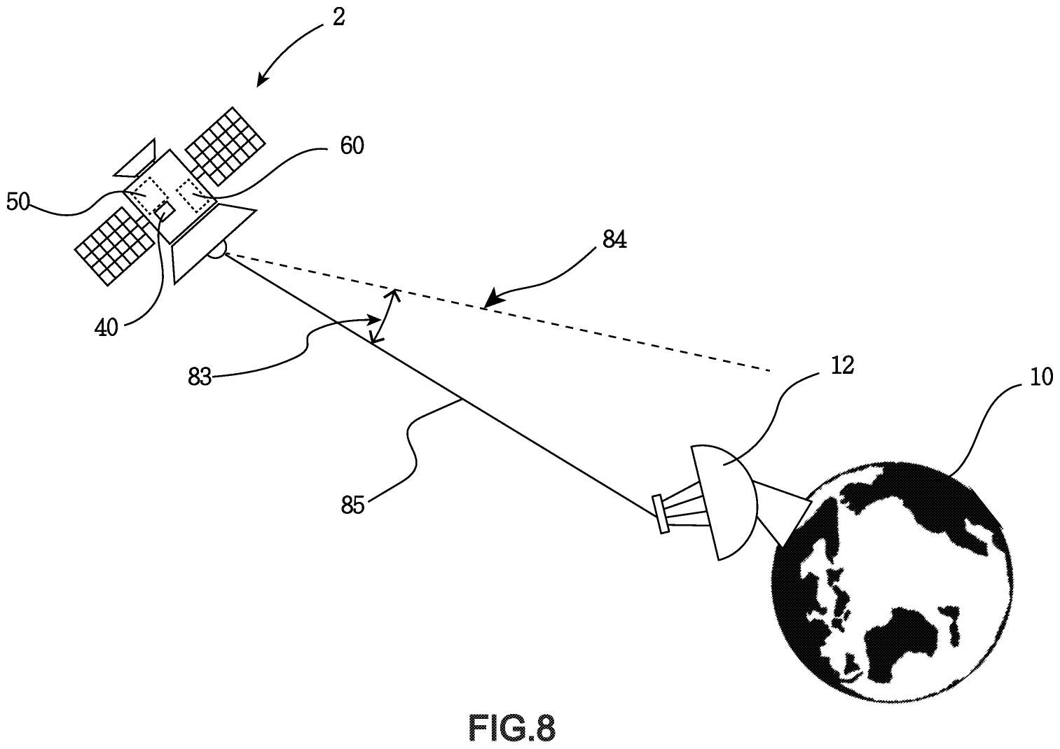

Please refer to FIGS. 4 to 8. FIG. 4 is a schematic view of an auto-alignment laser pointing system. FIG. 5 is a schematic view of some elements of an aircraft 2 using the laser light pointing system. FIG. 6 is a schematic view of some elements of the aircraft 2 using the auto-alignment laser pointing system. FIGS. 7 and 8 are schematic views of the operation of the aircraft 2 using this auto-alignment laser pointing system. The present disclosure provides an auto-alignment laser pointing system, which is applied to an aircraft 2 with a flight trajectory and includes a light source module 60, a beam control device 50, a tracking receiving module 12, and a gyroscope 40. The aircraft 2 may be an airplane, a satellite, or other flying device with a flight trajectory.

As shown in FIG. 5, the light source module 60 may generate a laser beam 61. The beam control device 50 may correspond to the light source module 60 to be set in a path of the laser beam 61 to control the laser beam 61 based on a set attitude angle 82 to form a projection beam 62, thereby changing the trajectory of the laser beam 61. For example, the set attitude angle 82 may be an attitude angle that allows the projection beam 62 to be projected onto the tracking receiving module 12. The tracking receiving module 12 may be used to track the aircraft 2 and receive the projection beam 62, thereby obtaining flight information of the aircraft 2.

As shown in FIGS. 6 to 8, the gyroscope 40 may be electrically connected to the beam control device 50 to sense an actual attitude angle 81 of the beam control device 50. Furthermore, when determining that there is a deviation angle 83 between the actual attitude angle 81 and the set attitude angle 82, the gyroscope 40 controls the beam control device 50 to rotate, for example, by rotating the mirror 51, to eliminate the deviation angle 83 and adjust the projection beam 62 path from the original beam path 84 to the corrected beam path 85, thereby ensuring that the projection beam 62 is projected onto the tracking receiving module 12.

The beam control device 50 may be a fast steering mirror (FSM) or other device that can control the beam. In this embodiment, the beam control device 50 includes a mirror 51, a plurality of sensing modules 52, and a control module 53. The mirror 51 is used to reflect the laser beam 61. The sensing modules 52 are placed corresponding to the mirror 51 and used for generating at least one sensing information. The control module 53 electrically connects to the sensing modules 52, rotates the mirror 51 based on the set attitude angle 82, and stops rotating the mirror 51 when the sensing information matches the set attitude angle 82, so control the laser beam 61 is controlled to form the projection beam 62. The tracking receiving module 12 may be a ground receiving station or other tracking-enabled receiving module.

The gyroscope 40 may be a mechanical gyroscope, a micro-electro-mechanical system gyroscope, a fiber optic gyroscope, a laser gyroscope, a hemispherical resonator gyroscope (HRG), and an integrated optic gyroscope, etc., but it is not limited thereto. In this embodiment, as shown in FIG. 6, the gyroscope 40 is a fiber optic gyroscope and includes a beam generation module 41 and a fiber coil module 42. The beam generation module 41 may be used to generate a driving beam 71 (such as a laser beam). The fiber coil module 42 may be connected to the beam generation module 41 to receive the driving beam 71 and be driven by the driving beam 71. The fiber coil module 42 includes a coupler 43, a modulation unit 44, a fiber coil 45, a detector 46, and a processing unit 47.

The coupler 43 is connected to the beam generation module 41 to receive the driving beam 71 and to split the driving beam 71. The modulation unit 44 is connected to the coupler 43 to modulate the phase of the driving beam 71, and to split or combine the received driving beam 71. The fiber coil 45 is connected to the modulation unit 44 and is used to transmit the driving beam 71. After transmission, the driving beam 71 is combined by the modulation unit 44. Specifically, the fiber coil 45 has two ends, which are respectively connected to the modulation unit 44, to allow the driving beam 71 to be transmitted from the modulation unit 44 to the fiber coil 45 and then transmitted back to the modulation unit 44. The detector 46 is connected to the coupler 43 to receive the driving beam 71 and to transmit a detection signal 72 accordingly. The detector 46 may be a photodetector, a photodiode, or any other unit with the function of detecting the beam, to convert the optical signal (the driving beam 71) into an electrical signal (the detection signal 72).

The processing unit 47 is electrically connected to the modulation unit 44, the detector 46, and the control module 53, and used to process and analyze the driving beam 71 and the detection signal 72. The processing unit 47 may be a central processing unit, a microcontroller, a field programmable gate array (FPGA) chip, or other processing and analyzing unit module or device. In practice, if the processing unit 47 only analyzes the detection signal 72, it can only detect the rotation speed of the gyroscope, but this rotation speed information does not have a directional nature. Therefore, the processing unit 47 provides a modulation signal to the modulation unit 44 to modulate the phase of the driving beam 71. Because the modulation signal may be a periodic wave signal such as a square wave with positive and negative (high and low voltage) signs, besides the rotation speed, the direction (clockwise or counterclockwise) can also be obtained, thus obtaining the actual attitude of the aircraft 2.

The gyroscope 40 can detect the angle and angular velocity, and can sense the actual attitude angle 81 of the beam control device 50 when the aircraft 2 rotates, vibrates, or deviates due to other factors. When the gyroscope 40 detects a deviation angle 83 between the actual attitude angle 81 and the set attitude angle 82, the gyroscope 40 controls the beam control device 50 to rotate (for example, by rotating the mirror 51) to eliminate this deviation angle 83, thereby ensuring that the projection beam 62 can be projected to the tracking receiving module 12. The tracking receiving module 12 can then receive the projection beam 62 and obtain flight information of the aircraft 2. The gyroscope 40 and the beam control device 50 in this invention form a closed loop, so the response time is much shorter than the time received feedback from the ground receiving station 11 to the satellite 1. Since the response time is very short, it even close to real-time control of the beam control device 50 to eliminate deviation angles.

It should be noted that regardless of the deviation angle 83 caused by the aircraft 2, the beam control device 50, or other factors, it can be sensed by the gyroscope 40 and further controlled to rotate the beam control device 50 to eliminate the deviation angle 83 based on this sensing result, thus solving the problems of prior arts. The gyroscope 40 is illustrated with the example of a fiber optic gyroscope, which can measure up to 0.01 degrees, meaning the mirror 51 may be driven either quickly or slowly. The zero bias stability of the fiber optic gyroscope can reach 0.1 degrees/hour, and its dynamic range can reach 1500 degrees/second. This means that fiber optic gyroscopes have high sensitivity, high measurement accuracy, fast response time, and reduced pointing errors. Therefore, gyroscope 40 combined with beam control device 50 may be seen as having both coarse and fine adjustment capabilities, and may solve the misalignment problem with only the beam control device 20 in the prior art.

In detail, satellites may be broadly categorized into geostationary satellites, medium earth orbit satellites, and low-orbit satellites based on their altitude. Geostationary satellites are located at an altitude of 36,000 km, medium earth orbit satellites are usually around 10,000 km, and low-orbit satellites are within 1,500 km. This invention is most commonly used in low-orbit satellites, including small satellites and CubeSats, which have more precise size and weight restrictions. The optimal transmission distance is around 1,000 km.

As of now, over 3000 CubeSats have been launched by humans, and the number of small satellite launches is constantly increasing. Foreign companies estimate that at least 8500 more small satellites will be added by 2028. When this invention is applied on satellites, the efficiency of receiving satellite information (flight information) can be effectively improved.

Regarding medium earth orbit satellites and geostationary satellites, because they are farther away from the earth, the laser beam needs to reach a certain power to be effectively implemented. In practice, satellites farther away usually communicate with each other through satellite-to-satellite communication, rather than direct transmission back to the earth. This invention may also be applied to two satellites that communicate with each other through satellite-to-satellite communication. The light source module 60, the beam control device 50, and the gyroscope 40 may be disposed on one satellite, while the tracking receiving module 12 is disposed on another satellite. This configuration may also carry out communication and ensure that the laser beam 61 from the light source module 60 on one satellite is projected to the tracking receiving module 12 on another satellite, to improve the accuracy and efficiency of message transmission.

The auto-alignment laser pointing system provided by this invention uses laser beams, compared to traditional satellite communication's radio waves which are transmitted in a dispersed state. The signals of traditional satellite communication go through different paths to reach the receiving module, and due to differences in the transmission path environment, the signals also experience attenuation and delay, and the data density that may be transmitted is lower in a dispersed state. This invention uses laser beams, with a far smaller divergent angle than traditional radio waves, resulting in better directionality and a higher data density that may be transmitted. In traditional satellite communication using radio waves, if misalignment occurs between the tracking receiving module and the radio signal transmitter, it will cause gain loss and affect the signal power received by the tracking receiving module. The invention uses a gyroscope to sense in real-time if there is a deviation angle, and then controls the beam control device to rotate and eliminate the deviation angle, ensuring that the tracking receiving module and the beam control device may be aligned. Therefore, the tracking receiving module may effectively receive the projected beam.

Therefore, compared to any prior arts, the present invention has at least one advantage that prior arts cannot achieve, such as ensuring alignment in receiving the projected beam, increasing the data transmission density, and reducing gain loss, etc.

While the invention has been described by way of example and in terms of the preferred embodiments, it should be understood that the invention is not limited to the disclosed embodiments. On the contrary, it is intended to cover various modifications and similar arrangements (as would be apparent to those skilled in the art). Therefore, the scope of the appended claims should be accorded the broadest interpretation so as to encompass all such modifications and similar arrangements.

1. An auto-alignment laser pointing system used in an aircraft having a flight path, comprising:
a light source module, used for generating a laser beam;
a beam control device, corresponding to the light source module and disposed in a path of the laser beam, and used for controlling the laser beam to form a projection beam based on a set attitude angle;
a tracking receiving module, used for tracking the aircraft and receiving the projection beam, so as to know flight information of the aircraft; and
a gyroscope, electrically connected to the beam control device to detect an actual attitude angle of the beam control device, when a deviation angle is between the actual attitude angle and the set attitude angle, the beam control device is controlled by the gyroscope to rotate for eliminating the deviation angle, and the projection beam is ensured projecting to the tracking receiving module.

2. The auto-alignment laser pointing system as claimed in claim 1, wherein the beam control device is a fast steering mirror (FSM).

3. The auto-alignment laser pointing system as claimed in claim 1, wherein the beam control device comprises:
a mirror, used for reflecting the laser beam;
a plurality of sensing modules, placed corresponding to the mirror and used for generating at least one sensing information; and
a control module, electrically connected to the sensing modules, used for rotating the mirror based on the set attitude angle, and stopping rotating the mirror when the sensing information matches the set attitude angle, to control the laser beam for forming the projection beam.

4. The auto-alignment laser pointing system as claimed in claim 3, wherein the gyroscope is a fiber optic gyroscope.

5. The auto-alignment laser pointing system as claimed in claim 4, wherein the gyroscope comprises:
a beam generation module, used for generating a driving beam; and
a fiber coil module, connected to the beam generation module to receive the driving beam and be driven by the driving beam.

6. The auto-alignment laser pointing system as claimed in claim 5, wherein the fiber coil module comprises:
a coupler, connected to the beam generation module and used to receive the driving beam and to split the driving beam;
a modulation unit, connected to the coupler, used for modulating the phase of the driving beam and splitting or combine the received driving beam;
a fiber coil, connected to the modulation unit and used to transmit the driving beam;
a detector, connected to the coupler to receive the driving beam and to transmit a detection signal accordingly; and
a processing unit, electrically connected to the modulation unit, the detector, and the control module, and used to process and analyze the driving beam and the detection signal.

7. (canceled)

8. The auto-alignment laser pointing system as claimed in claim 6, wherein the modulation unit is a multifunctional integrated optical chip.

9. The auto-alignment laser pointing system as claimed in claim 3, wherein the gyroscope is one of a micro-electro-mechanical system gyroscope, a mechanical gyroscope, a laser gyroscope, a hemispherical resonator gyroscope, and an integrated optic gyroscope.

10. The auto-alignment laser pointing system as claimed in claim 1, wherein the tracking receiving module is a ground receiving station.

11. The auto-alignment laser pointing system as claimed in claim 6, wherein the processing unit is a field programmable gate array chip.
